(19) United States
(12) Patent Application Publication
(10) Pub. No.: US 2006/0165931 A1
(43) Pub. Date: Jul. 27, 2006

(54) Utility box cover

(76) Inventors: John Gaulrapp, Cave Creek, AZ (US); Michael J. Plucinsky, Phoenix, AZ (US)

Correspondence Address: The Halvorson Law Firm, Ste 130, 1757 E. Baseline, Gilbert, AZ, 85233, US

(21) Appl. No.: 11/044,476

(22) Filed: Jan. 27, 2005

(51) Int. Cl. B60R 21/16

(52) U.S. Cl. 428/36.1

(57) ABSTRACT

A cover for utility boxes and the like. This cover has on the fabric of the cover a non-projecting pattern that functions to, when installed on the utility boxes, reduce the visual impact of the utility boxes on the surrounding landscape.

### FIELD OF THE INVENTION

The present invention generally relates to covers for utility boxes and the like. More specifically, the present invention relates to cover for utility boxes and the like that have patterns thereon that reduce the visual outline of the utility box.

### DESCRIPTION OF THE PRIOR ART

Utility boxes and other like cabinets are a necessary part of residential and commercial landscapes. However, these boxes are designed with for function and not esthetics. This leads to many of the boxes being located in places where they are acutely obvious. This typically reduces the esthetic beauty of the surrounding areas.

Typically there are two solutions to this problem, first located the boxes in a place where they are not visible. This solution frequently is not available, especially for utility boxes and the like. The second solution is to landscape around the utility box in a manner that hides the boxes. While this solution works, there are many environments where one cannot easily surround the boxes with bushes and the like. Also, landscaping around the boxes frequently reduce their accessibility, something utility are typically against.

Covers for air conditioning units are known. See for example U.S. Pat. Nos. 5,307,849, 5,097,678, 4,745,769, 3,320,996, and 2,705,990. These covers are designed to protect the air conditioner contained therein and do not disclose any method or pattern that would reduce the visual outline of the air conditioner.

Camouflage covers are known. The military is famous for utilizing camouflage for hiding vehicles and encampments. These covers are designed for use in wooded or other non-populated areas where camouflage is useful for fully concealing the vehicle underneath. See for example, U.S. Pat. No. 5,079,048. These covers are unuseful in an urban setting where landscaping may be more regular and where total concealment is not required.

Netting for covering utility boxes having simulated foliage attached thereon are known. See for example U.S. Pat. No. 5,989,656. This cover, while useful for some concealment of utility boxes in some landscape backgrounds, cannot be used with landscapes that do not have a lot of foliage, such as zeroscapes.

As a result, there is a need for cover for utility boxes and the like that reduces the visual outline of such boxes and the like.

### SUMMARY OF THE INVENTION

It is an object of the present invention to provide a cover for utility boxes and the like that reduce their visual outline.

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. § 112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### DESCRIPTION OF THE DRAWINGS

FIG. 1 illustrates an uncovered set of utility boxes with some minimal landscaping next to the boxes.

FIG. 2 illustrates a first step in covering the same set of utility boxes with the present invention.

FIG. 3 illustrates a continuation of the covering step of the same set of utility boxes.

FIG. 4 illustrates the same set of utility boxes in a full covered state and with a reduced visual impact.

FIG. 5 shows an alternate landscape scheme with uncovered utility boxes.

FIG. 6 illustrates a person in the process of covering one of the uncovered utility boxes.

FIG. 7 illustrates that same person finalizing the covering of the uncovered utility boxes.

FIG. 8 illustrates how the present invention works to reduce the visual impact of utility boxes in alternate landscape schemes.

### DESCRIPTION OF THE PREFERRED EMBODIMENTS

While the invention is susceptible to various modifications and alternative constructions, the preferred embodiment is shown in the drawings and will be described below in detail. It should be understood, however, that there is no intention to limit the invention to the specific form disclosed, but, on the contrary, the invention is to cover all modifications, alternative constructions, and equivalents falling within the spirit and the scope of the invention as defined in the claims.

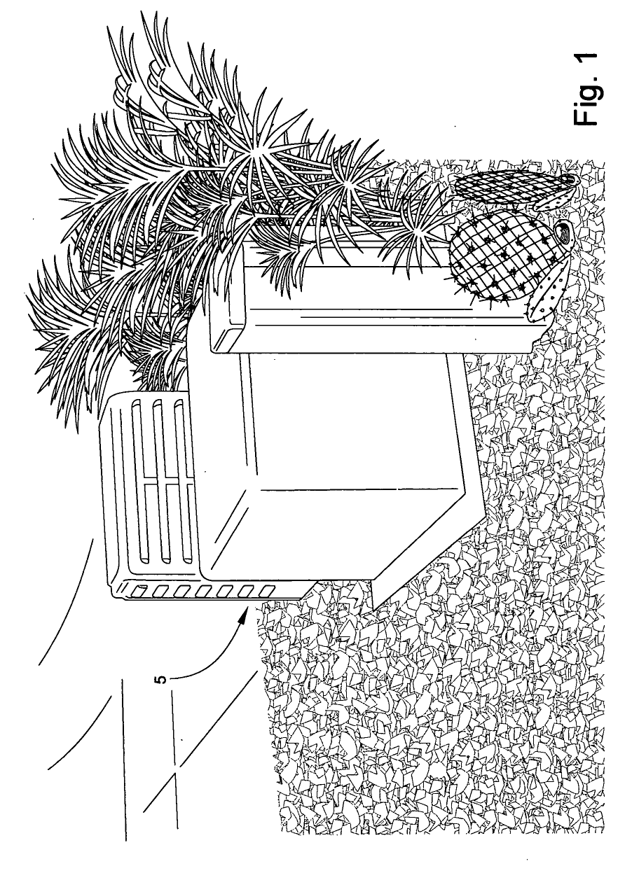

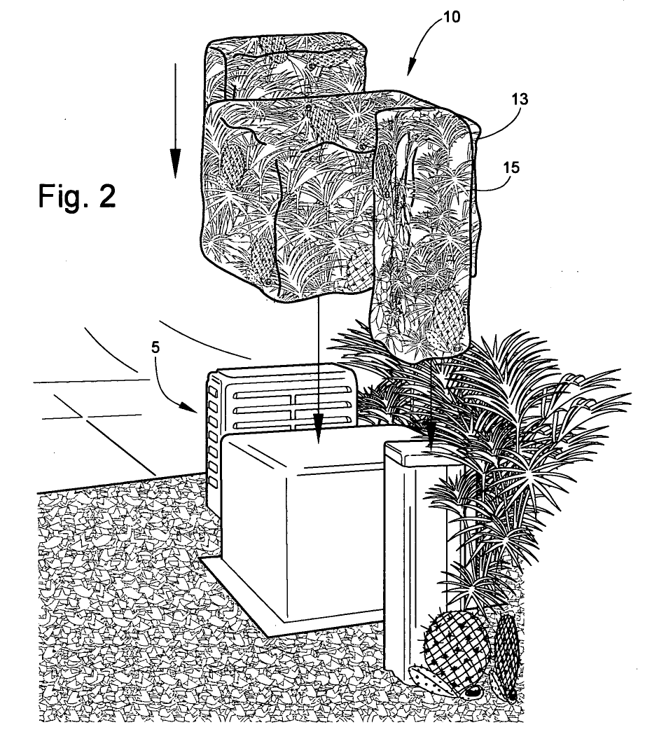

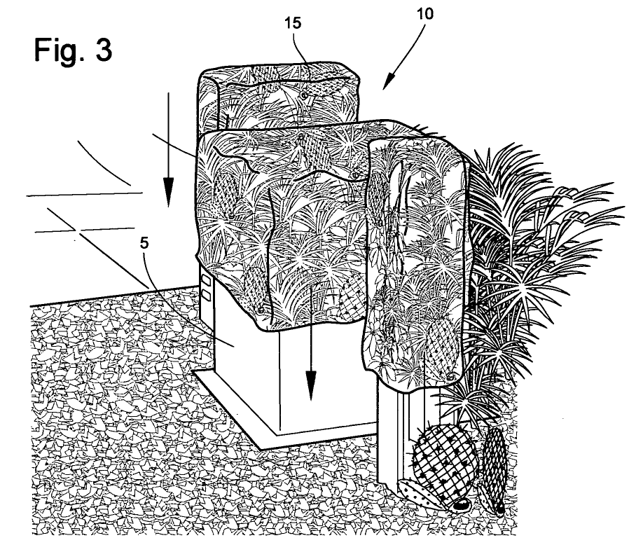

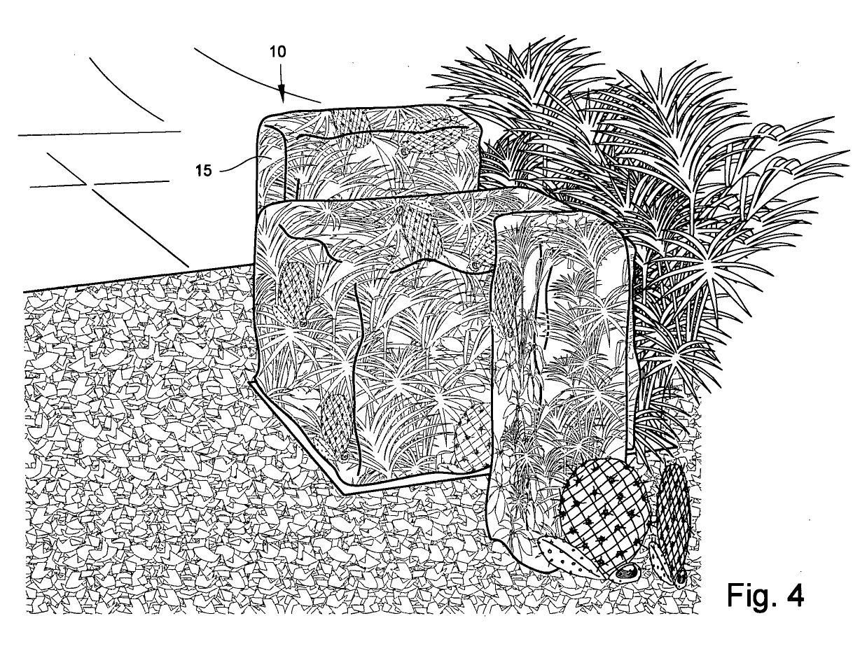

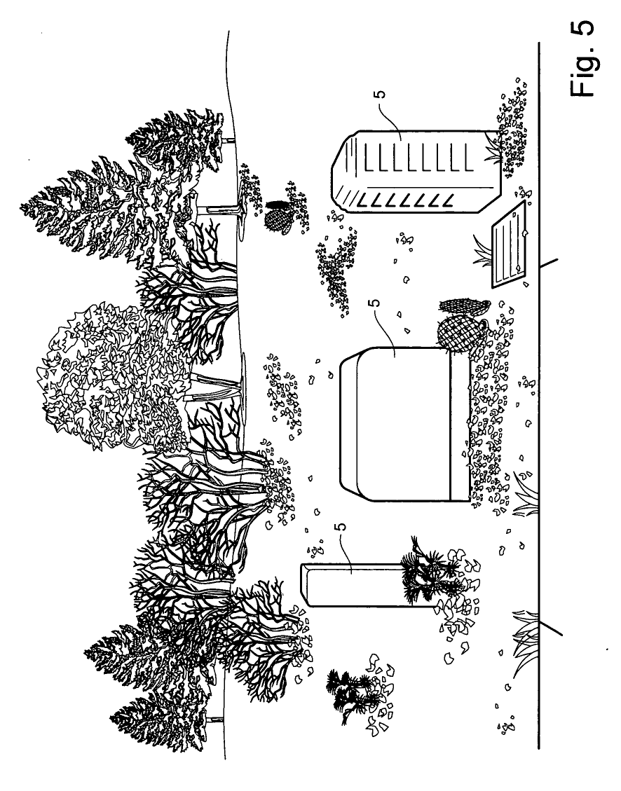

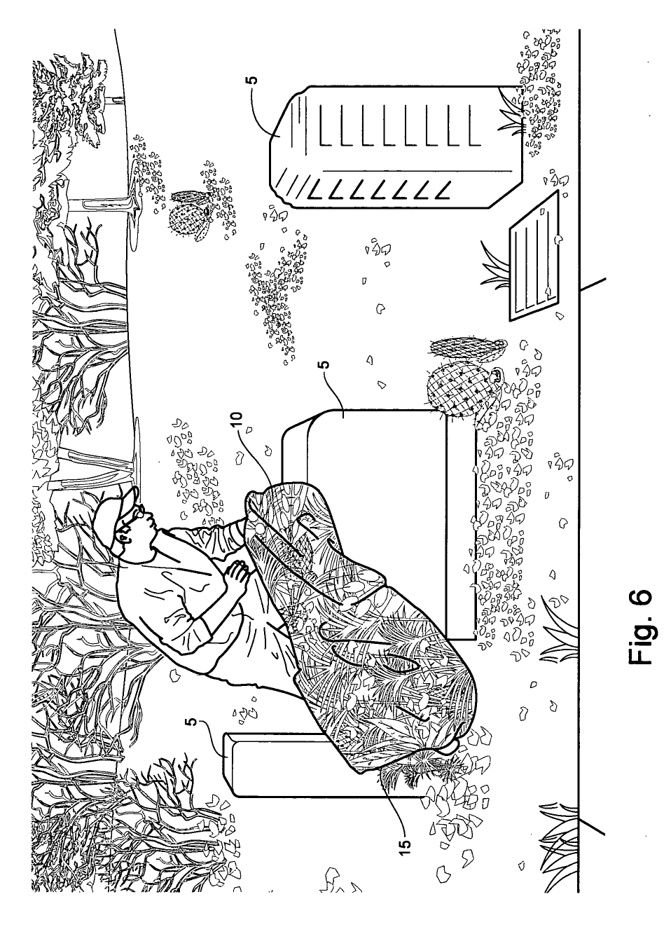

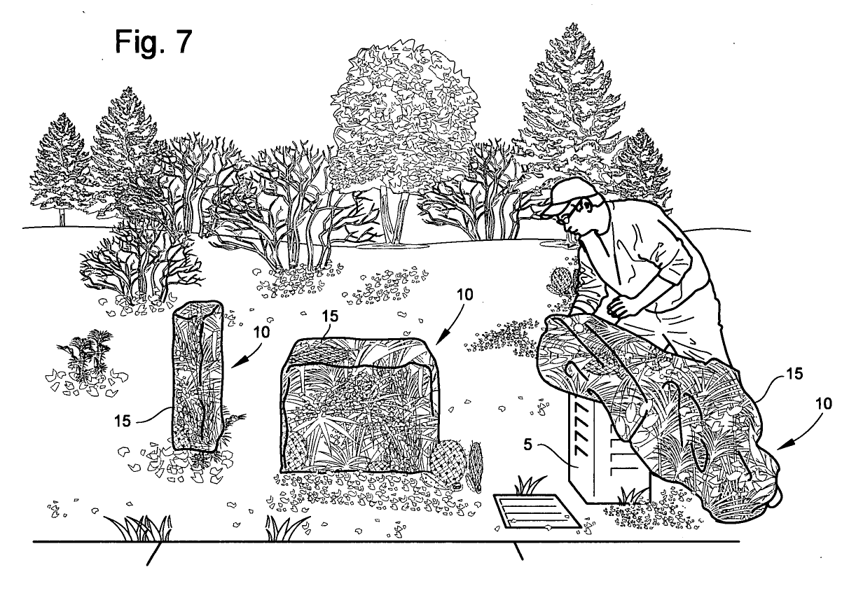

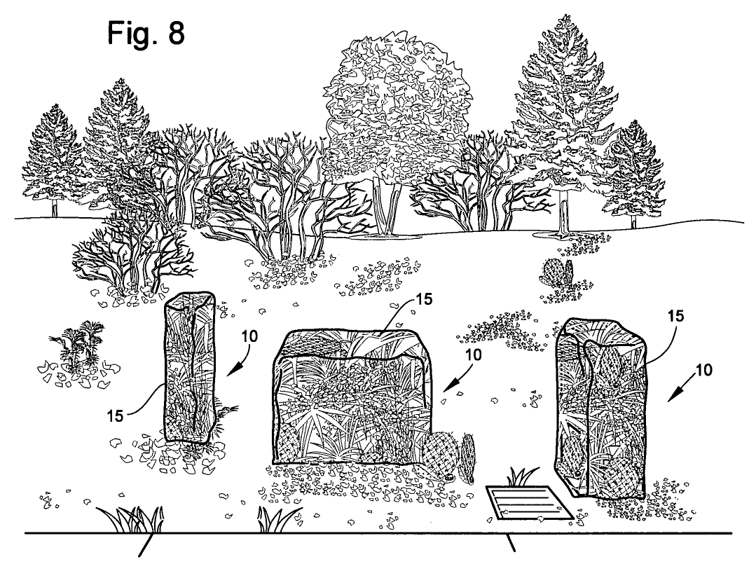

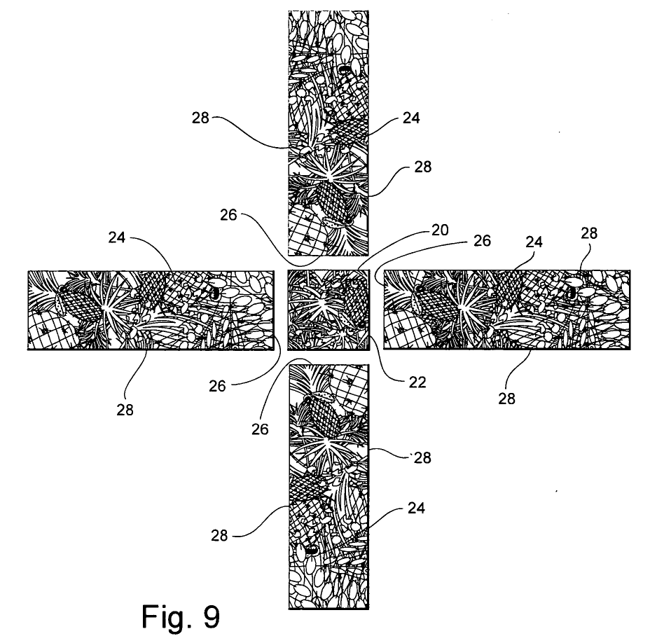

As illustrated in FIG. 1, uncovered utility boxes 5 have an adverse visual impact on immediate landscaping. This adverse visual impact is both jarring to the eye and unharmonious to the esthetic of the landscaping that surrounds the uncovered utility box. The present invention is a cover 10 for utility boxes 5 and the like that reduces the visual impact of the utility boxes 5. This cover 10 has on the fabric of the cover a non-projecting pattern 15 that is the functional component that, when installed on the utility boxes 5, reduce the visual impact of the utility boxes on the surrounding landscape.

The pattern 15 on the covers 10 of the present invention are printed directly on the fabric of the cover 10 and are not simulated foliage that projects off of the fabric. Thus the pattern 15 used in the present invention relies solely upon visual misdirection rather than projecting or textured misdirection. In a preferred embodiment, the pattern 15 is designed to closely simulate the landscaping surrounding the utility boxes 10, such as cacti and gravel for desert situations.

The cover 10 of the present invention is preferably formed or sized to fit snuggly the utility box 5 upon which it is installed while still allowing easy access to the utility box 5.

The preferred cover 10 has a fabric base 13 comprising a regularly shaped top 20, typically square or rectangular and having four edges 22, that is attached, preferably stitched along the four edges 22 to the top edges 26 of each of four sides 24, said sides 24 further each attached to the other along common sides 28, preferably also by stitching, to form an open sided cube or rectangular prism. For cylindrical utility boxes 5, the fabric base would comprise a circular top piece attached to a side piece, the side piece being attached to the perimeter of the circular top piece along one edge to form an open sided cylinder. In all embodiments, the open side is placed over the utility box 5 thereby covering the utility box 5 with the cover 10 of the present invention.

Alternately, one or more of the attached edges may be releasably attached to each other, such as with a zipper or a hook and loop fastener, to allow for easier access to the covered utility box 5.

The fabric of the cover 10 is preferably a close weave fabric, but more open weaves may be used and still fall within the scope of the present invention.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

We claim:

1. A fabric cover comprising a formed fabric base that comprises a top fabric piece attached to at least one side fabric piece to form an open ended cylinder; said top and at least one side fabric piece further comprising a non-projecting pattern printed on the fabric, said printed non-projecting pattern sufficient to reduce the outline of a container when the container cover is placed over the container.

2. The fabric cover according to claim 1 wherein the non-projecting pattern is a desert landscape.

3. The fabric cover according to claim 1 wherein the non-projecting pattern is an urban landscape.

4. The fabric cover according to claim 1 wherein the non-projecting pattern is a brick pattern.

5. The fabric cover according to claim 1 wherein the non-projecting pattern is a stucco pattern.

6. The fabric cover according to claim 1 wherein the non-projecting pattern is a wood siding pattern.

7. A fabric cover comprising a formed fabric base that comprises a top fabric piece attached to four side fabric pieces to form an open ended prism; said top and side fabric pieces further comprising a non-projecting pattern printed on the fabric, said printed non-projecting pattern sufficient to reduce the outline of a container when the container cover is placed over the container.

8. The fabric cover according to claim 7 wherein the non-projecting pattern is a desert landscape.

9. The fabric cover according to claim 7 wherein the non-projecting pattern is an urban landscape.

10. The fabric cover according to claim 7 wherein the non-projecting pattern is a brick pattern.

11. The fabric cover according to claim 7 wherein the non-projecting pattern is a stucco pattern.

12. The fabric cover according to claim 7 wherein the non-projecting pattern is a wood siding pattern.
